(19) United States
(12) Patent Application Publication
(10) Pub. No.: US 2026/0274235 A1
(43) Pub. Date: Sep. 17, 2026

(54) ACTUATOR ASSEMBLY

(71) Applicant: ZF Active Safety GmbH, Koblenz (DE)

(72) Inventors: Lukas Madzgalla, Lahnstein (DE); Markus Reinhard, Lahnstein (DE); Florian Roessinger, Neuwied (DE)

(21) Appl. No.: 19/550,804

(22) Filed: Feb. 26, 2026

(30) Foreign Application Priority Data
Mar. 11, 2025 (DE) 102025109281.8

(51) Int. Cl. B60T 13/74; F16H 25/20; F16H 25/22

(52) U.S. Cl. CPC B60T 13/746; F16H 25/2204; F16H 2025/2087

(57) ABSTRACT

An actuator assembly for a vehicle brake is specified, with a brake calliper in which a gap for a brake rotor is formed, wherein arranged in the gap is a brake pad which can be applied to the brake rotor, a spindle drive which has a spindle nut and a spindle, driven by an electric motor, for axially moving the spindle nut, wherein the spindle nut can be shifted by axial displacement between a retracted and an extended position and presses against the brake pad in the extended position, wherein the spindle is supported radially and axially via a spherical roller bearing on the brake calliper or on a housing fastened to the brake calliper.

### TECHNICAL FIELD

The invention relates to an actuator assembly for a vehicle brake.

### BACKGROUND

Actuator assemblies are used in vehicle brakes to apply a brake pad to a brake rotor. For this purpose, the actuator assembly usually has a spindle drive which has a spindle nut and a spindle, driven by an electric motor, for axially moving the spindle nut, wherein an axial actuating force for applying the brake pad to the brake rotor is transmitted from the spindle nut to the brake pad.

When the vehicle brakes are applied, high lateral forces act on the brake pad and the spindle nut, causing a bending moment in the actuator assembly. Such lateral forces are undesirable as they lead to loss of performance and efficiency and promote wear of the actuator assembly. The lateral forces which occur change over the life of the actuator assembly owing to lining wear, which can lead to inaccuracies in the control of the vehicle brake or to changes in the braking behaviour.

In known actuator assemblies, a spherical bearing disk is arranged on a contact surface of the spindle directed away from the brake pad. However, because of the relatively large distance to the brake pad, this does not sufficiently eliminate lateral forces in the actuator assembly.

### SUMMARY

It is therefore an object of the present invention to provide an improved solution for avoiding lateral forces in an actuator assembly of a vehicle brake.

This object is achieved according to the invention by an actuator assembly for a vehicle brake, with a brake calliper in which a gap for a brake rotor is formed, wherein arranged in the gap is a brake pad which can be applied to the brake rotor, a spindle drive which has a spindle nut and a spindle, driven by an electric motor, for axially moving the spindle nut, wherein the spindle nut can be shifted by axial displacement between a retracted and an extended position and presses against the brake pad in the extended position, wherein the spindle is supported radially and axially on the brake calliper or on a housing fastened to the brake calliper via a spherical roller bearing.

The use of the spherical roller bearing enables mounting with no axial and radial play.

Spherical roller bearings are generally used to compensate tilting and misalignment. In the actuator assembly according to the invention, the spherical roller bearing makes it possible to compensate the oscillating movement of the spindle when the actuator assembly is clamped. As a result, lateral forces and bending moments in the actuator assembly are largely avoided such that less wear occurs and consequently the life of the actuator assembly is increased. By avoiding lateral forces, the load on axial bearings present in the actuator assembly is also relieved. Loss forces due to friction are also reduced, which optimizes the efficiency of the actuator assembly.

In the case of a vehicle brake with an actuator assembly according to the invention, pressure distribution at the brake pad is also particularly uniform, as a result of which uniform wear takes place over the surface. In other words, angular wear is avoided.

The actuator assembly comprises, for example, an electric motor for driving the spindle, the electric motor being coupled to the spindle via a gear unit, wherein an output element of the gear unit is coupled to the spindle in a torque-transmitting manner, in particular is formed integrally with the spindle. Efficient driving of the spindle is possible by means of the electric motor. By virtue of the integral production of the spindle with the output element, there is no mechanical play at the interface of the gear unit with the spindle drive, which allows torque to be transmitted particularly efficiently.

According to one aspect, the gear unit comprises a planetary gear and a planet gear carrier of the planetary gear forms the output element of the gear unit. Because the planet gear carrier functions directly as an output element, the torque can be transmitted without detours or losses. This increases the efficiency of the system and minimizes mechanical losses.

For example, the planet gear carrier is disk-shaped. In this way, a continuous contact surface for the spherical roller bearing is present at the planet gear carrier.

According to one embodiment, the spindle is in two parts and has a spindle shaft and a spindle sleeve, wherein a joint is formed between the spindle shaft and the spindle sleeve such that the spindle shaft can be tilted relative to the spindle sleeve. By virtue of the joint, at least a certain proportion of the lateral forces and bending moments that occur can already be compensated within the spindle, as a result of which the load on the spherical roller bearing is relieved. By virtue of the joint in combination with the spherical roller bearing, the majority of the lateral forces and bending moments that occur can be compensated.

The spindle sleeve can be retained axially on the spindle shaft by means of at least one elastic element, wherein the at least one elastic element is fastened to the spindle shaft by means of a fastening means. The elastic element causes the spindle sleeve to be retained on to the spindle shaft under compressive stress. In addition, the elastic element, in contrast to a fully rigid fastening means, allows the necessary movement of the spindle sleeve relative to the spindle shaft in order to allow the desired tilting movement of the joint.

According to one aspect, the spindle sleeve has a front wall with a through opening, part of which has a receptacle for an extension of the spindle shaft, wherein the through opening has a portion facing away from the spherical roller bearing and with a larger cross section, from which the fastening means is inserted into the front of the spindle sleeve, wherein arranged between a head of the fastening means and the bottom of the section portion with a larger cross section is the at least one elastic element which is prestressed by the fastening means, wherein the fastening means also axially prestresses the spherical roller bearing. The fastening means is, for example, a screw. The elastic element is, for example, a disk spring stack.

Because the head of the fastening means is arranged in the portion with a larger cross section, a particularly compact design is achieved.

The elastic element, in particular the disk spring stack, ensures tolerance compensation in the axial direction.

The spherical roller bearing can be axially supported with its outer ring on the brake calliper or on a housing fastened to the brake calliper, and the inner ring of the spherical roller bearing can be accommodated in the brake calliper or in a housing fastened to the brake calliper. Because the spherical roller bearing is supported axially with its outer ring on the brake calliper or on a housing fastened to the brake calliper, lateral forces and bending moments, if they are not already compensated in the spherical roller bearing, can be diverted into the brake calliper or a housing fastened to the brake calliper. The arrangement of the inner ring in the brake calliper or in a housing fastened to the brake calliper contributes to a compact design.

According to one aspect, the spindle is axially supported via an axial bearing on the brake calliper or on a housing fastened to the brake calliper, wherein an intermediate element is arranged between the axial bearing and the spindle, which intermediate element has a spherically shaped surface on its side directed toward the spindle, against which the spindle bears. By virtue of such an intermediate element, a better load distribution of the axially acting force on the axial bearing is achieved.

For example, a centre point of the spherical surface is located in the gap for accommodating the brake rotor. Consequently, a particularly advantageous curvature of the spherical surface is achieved, in particular in such a way that the intermediate element does not block tilting of the output sleeve relative to the spindle shaft.

The spindle sleeve can be applied against the spherically shaped surface by the at least one elastic element. The elastic element consequently effects tolerance compensation, as a result of which the spindle sleeve bears against the spherical surface without play.

### BRIEF DESCRIPTION OF THE DRAWINGS

Further advantages and features of the invention will become apparent from the following description and from the accompanying drawings, to which reference is made. In the drawings:

FIG. 1 shows a perspective illustration in section of an actuator assembly according to the invention, and

FIG. 2 shows the actuator module from FIG. 1 in a further illustration in section.

### DESCRIPTION

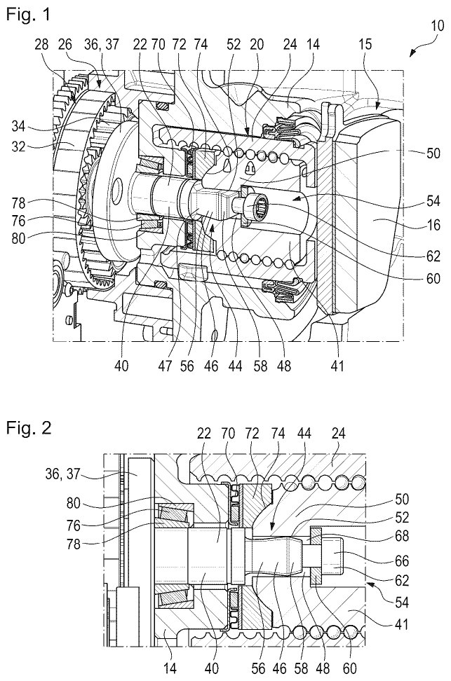

FIG. 1 shows an actuator assembly 10 for an electromechanical vehicle brake.

The actuator assembly 10 comprises a brake calliper 14, in which a gap 15 for a brake rotor is formed. The brake rotor is not visible in the figures.

Brake pads 16 which can be applied to the brake rotor are arranged in the gap.

The actuator assembly 10 comprises a spindle drive 20 which in the exemplary embodiment is a ball screw, with a rotatably mounted spindle 22 on which a linearly guided spindle nut 24 is mounted.

To apply the brake pads 16 to the brake rotor, the spindle nut 24 can be shifted by axial displacement between a first, retracted position and a second, extended position. In the extended position, the spindle nut 24 presses against the brake pad 16.

In the exemplary embodiment, the spindle nut 24 forms a brake piston, i.e. the spindle nut 24 presses directly against the brake pad 16. However, it is also conceivable that the spindle nut 24 presses indirectly against the brake pad 16 via an additional brake piston mounted on the spindle nut 24.

Axial shifting of the spindle nut 24 is effected by rotation of the spindle 22. For this purpose, the spindle 22 is driven by an electric motor.

An electric motor not visible in the figures is coupled to the spindle 22 for driving the spindle 22 via a gear unit 26.

The gear unit 26 comprises a planetary gear 28 with a driven sun gear which is covered in the figures, a ring gear 32, a plurality of planet gears 34, and a planet gear carrier 36.

The planet gear carrier 36 is disk-shaped.

The planet gear carrier 36 forms an output element 37 of the gear unit 26 and is coupled to the spindle 22 in a torque-transmitting manner.

In the exemplary embodiment, the planet gear carrier 36 is formed integrally with the spindle 22.

In the force path between the output element 37 of the gear unit 26, i.e. the planet gear carrier 36, and the spindle nut 24, a joint 44 is formed via which the spindle nut 24 can be tilted relative to the output element 37.

The spindle 22 is formed in two parts in the exemplary embodiment and comprises, in addition to a spindle shaft 40, a spindle sleeve 41 formed separately from the spindle shaft 40, wherein the joint 44 is formed between the spindle shaft 40 and the spindle sleeve 41.

The joint 44 comprises a joint head 46 and a receptacle 48 for the joint head 46.

The joint head 46 is arranged on an extension 47 of the spindle shaft 40, which is received in the spindle sleeve 41. The receptacle 48 is thus formed in the spindle sleeve 41.

Specifically, the spindle sleeve 41 has a end wall 50 with a through opening 52 which, in a portion directed toward the gear unit 26, has the receptacle 48 for the extension 47 and the joint head 46 of the spindle shaft 40.

The through opening 52 has, axially following the receptacle 48, a portion 54 with a larger cross section, the purpose of which is described below. The portion 54 with a larger cross section is directed toward the gap 15.

The joint head 46 has two portions 56, 58 which taper in opposite directions.

More specifically, the joint head 46 has the form of two truncated pyramids which are connected to each other at their base. Each truncated pyramid forms one of the tapering portions 56, 58.

At the transition between the two tapering portions 56, 58, the joint head 46 is rounded off.

Because the joint 44 allows the spindle sleeve 41 to be able to tilt relative to the spindle shaft 40, lateral forces which can occur when actuating the actuator assembly 10 can be eliminated.

The side faces of the truncated pyramids form an abutment when the spindle sleeve 41 tilts if the spindle sleeve 41 is tilted so far that a side face of a truncated pyramid bears against the whole surface of an inner side of the receptacle 48.

The spindle sleeve 41 is axially retained on the spindle shaft 40 by means of an elastic element 60. The elastic element 60 is, for example, a disk spring or a disk spring stack. An elastically compressible ring is also conceivable.

The elastic element 60 is fastened to the spindle shaft 40 by means of a fastening means 62. In the exemplary embodiment, the fastening means 62 is a screw. The spindle shaft 40 has a corresponding screw hole.

However, the fastening means 62 can also be peened or riveted to the spindle shaft 40.

The fastening means 62 is inserted from the portion 54 with a larger cross section into the front of the spindle sleeve 41, wherein arranged between a head 66 of the fastening means 62 and the bottom 68 of the portion 54 with a larger cross section is the elastic element 60, to be more precise a disk spring stack which is prestressed by the fastening means 62.

The spindle 22, as illustrated in FIG. 1, is axially supported on the brake calliper 14 via an axial bearing 70, wherein arranged between the axial bearing 70 and the spindle 22 is an intermediate element 72 which, on its side directed toward the spindle 22, has a spherically shaped surface 74 against which the spindle 22, or to be more precise the spindle sleeve 41, bears. The spindle 22 or the spindle sleeve 41 is consequently supported on the axial bearing 70 in each angular position via the intermediate element 72.

The spindle sleeve 41 is applied by the elastic element 60 against the spherically shaped surface 74.

The spindle 22 is moreover supported radially and axially on the brake calliper 14 via a spherical roller bearing 76. Alternatively, the spherical roller bearing 76 can support the spindle 22 on a housing fastened to the brake calliper 14, if such a housing is present.

The spherical roller bearing 76 is axially prestressed by the fastening means 62. Specifically, the fastening means 62 in combination with the elastic element 60 pulls the spindle shaft 40 with the planet gear carrier 36, formed integrally with the latter, and the spindle sleeve 41 toward each other such that the planet gear carrier 36 presses the spherical roller bearing 76 axially against the brake calliper 14.

In the exemplary embodiment, an inner ring 78 of the spherical roller bearing 76 is supported axially on the planet gear carrier 36 and radially on the spindle shaft 40. An outer ring 80 of the spherical roller bearing is supported axially and radially on the brake calliper 14. The inner ring 78 of the spherical roller bearing 76 is accommodated in the brake calliper 14.

The spherical roller bearing 76 also ensures angular compensation between the spindle nut 24 and an input of the gear unit 26.

1. Actuator assembly for a vehicle brake, with
a brake calliper in which a gap for a brake rotor is formed, wherein a brake pad which can be applied to the brake rotor is arranged in the gap,
a spindle drive which has a spindle nut and a spindle, driven by an electric motor, for axially moving the spindle nut, wherein the spindle nut can be shifted by axial displacement between a retracted and an extended position and presses against the brake pad in the extended position,
wherein the spindle is supported radially and axially via a spherical roller bearing on the brake calliper or on a housing fastened to the brake calliper.

2. Actuator assembly according to claim 1, wherein the actuator assembly comprises an electric motor for driving the spindle, which is coupled via a gear unit to the spindle, wherein an output element of the gear unit is coupled to the spindle in a torque-transmitting manner, in particular is formed integrally with the spindle.

3. Actuator assembly according to claim 2, wherein the gear unit comprises a planetary gear, and a planet gear carrier of the planetary gear forms the output element of the gear unit.

4. Actuator assembly according to claim 3, wherein the planet gear carrier is disk-shaped.

5. Actuator assembly according to claim 1, wherein the spindle is in two parts and has a spindle shaft and a spindle sleeve, wherein a joint is formed between the spindle shaft and the spindle sleeve such that the spindle shaft can be tilted relative to the spindle sleeve.

6. Actuator assembly according to claim 5, wherein the spindle sleeve is axially retained on the spindle shaft by means of at least one elastic element, wherein the at least one elastic element is fastened to the spindle shaft by means of a fastening means.

7. Actuator assembly according to claim 6, wherein the spindle sleeve has a front wall with a through opening, part of which has a receptacle for an extension of the spindle shaft wherein the through opening has a portion which faces away from the spherical roller bearing and has a larger cross section and from which the fastening means is inserted into the front of the spindle sleeve, wherein arranged between a head of the fastening means and the bottom of the portion with a larger cross section is the at least one elastic element which is prestressed by the fastening means, wherein the fastening means also axially prestresses the spherical roller bearing.

8. Actuator assembly according to claim 7, wherein the spherical roller bearing is axially supported with its outer ring on the brake calliper or on a housing fastened to the brake calliper, and the inner ring of the spherical roller bearing is accommodated in the brake calliper or in a housing fastened to the brake calliper.

9. Actuator assembly according to claim 1, wherein the spindle is axially supported via an axial bearing on the brake calliper or on a housing fastened to the brake calliper, wherein arranged between the axial bearing and the spindle is an intermediate element which has a spherically shaped surface on its side directed toward the spindle, against which the spindle bears.

10. Actuator assembly according to claim 6, wherein the spindle is axially supported via an axial bearing on the brake calliper or on a housing fastened to the brake calliper, wherein arranged between the axial bearing and the spindle is an intermediate element which has a spherically shaped surface on its side directed toward the spindle, against which the spindle bears, wherein the spindle sleeve is applied against the spherically shaped surface by the at least one elastic element.
